(19) United States
(12) Patent Application Publication
(10) Pub. No.: US 2012/0125803 A1
(43) Pub. Date: May 24, 2012

(54) DEVICE HOUSING AND METHOD FOR MAKING THE SAME

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); LI-QUAN PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/156,547

(22) Filed: Jun. 9, 2011

(30) Foreign Application Priority Data
Nov. 23, 2010 (CN) 201010555145.X

(51) Int. Cl. B65D 85/00; B23P 17/00

(52) U.S. Cl. 206/525; 29/592

(57) ABSTRACT

A device housing is provided. The device housing includes a substrate, and an anti-fingerprint film formed on the substrate. The anti-fingerprint film is a nano-composite coating consisting essentially of tin oxide. A method for making the device housing is also described.

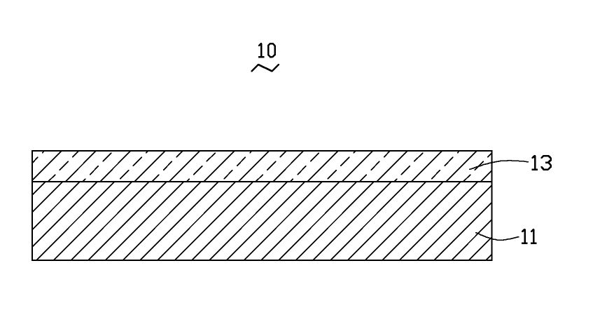

### BACKGROUND

1. Technical Field

The present disclosure relates to device housings, particularly to a device housing having an anti-fingerprint property and a method for making the device housing.

2. Description of Related Art

Many electronic device housings are coated with anti-fingerprint film. These anti-fingerprint films are commonly a paint containing organic anti-fingerprint substances. However, the print films are thick (commonly 2 μm-4 μm) and not very effective. Furthermore, the paint may not be environmentally friendly.

Therefore, there is room for improvement within the art.

### BRIEF DESCRIPTION OF THE FIGURE

Many aspects of the device housing can be better understood with reference to the following FIGURE. The components in the FIGURE are not necessarily drawn to scale, the emphasis instead being placed upon clearly illustrating the principles of the device housing.

The FIGURE is a cross-section view of an exemplary embodiment of a device housing.

### DETAILED DESCRIPTION

The FIGURE shows a device housing 10 according to an exemplary embodiment. The device housing 10 includes a substrate 11, and an anti-fingerprint film 13 formed on a surface of the substrate 11.

The substrate 11 may be made of metal or non-metal material. The metal may be selected from a group consisting of stainless steel, aluminum, aluminum alloy, copper, copper alloy, and zinc. The non-metal material may be plastic, ceramic, or glass. The substrate 11 has a coarse or rugged surface having roughness in a range between about 0.1 μm and about 0.2 μm.

The anti-fingerprint film 13 is a nano-composite coating consisting essentially of tin oxide. The nano-composite coating can be provided by depositing tin oxide onto the substrate 11 using vapor phase deposition. Examples of vapor phase deposition techniques that can be employed to deposit the nano-composite coating on the substrate 11 include physical vapor deposition, and chemical vapor deposition. It will be appreciated that other deposition methods of providing the nano-composite coating can also be employed. The anti-fingerprint film 13 made in this manner has a good anti-fingerprint property.

The anti-fingerprint film 13 is transparent. The thickness of the anti-fingerprint film 13 is under 2000 nm. In this exemplary embodiment, the anti-fingerprint film 13 has a thickness of only about 100 to about 500 nm. An environmentally friendly vacuum sputtering process may directly form the anti-fingerprint film 13, and the anti-fingerprint film 13 is tightly bonded to the coarse or rugged surface of the substrate 11.

A method for making the device housing 10 may include the following steps:

The substrate 11 is pretreated. The pre-treating process may include the following steps:

The substrate 11 is cleaned in an ultrasonic cleaning device (not shown), filled with ethanol or acetone.

The substrate 11 is plasma cleaned. The substrate 11 may be positioned in a plating chamber of a vacuum sputtering machine (not shown). The plating chamber is fixed with a target therein. The target is made of Sn. The plating chamber is then evacuated to about 3.0×10⁻³ Pa. Argon (Ar, having a purity of about 99.999%) may be used as a working gas and injected into the chamber at a flow rate from about 300 to about 500 standard cubic centimeter per minute (sccm). The substrate 11 may be biased with negative bias voltage at a range of −300 V to about −500 V, then high-frequency voltage is produced in the plating chamber and the Ar is ionized to plasma. The plasma then strikes the surface of the substrate 11 to clean the surface of the substrate 11. Plasma cleaning the substrate 11 may take about 20 mins to about 30 mins. The plasma cleaning process makes the substrate 11 form a coarse or rugged surface having a roughness at a range between about 0.1 μm and about 0.2 μm. The coarse or rugged surface can enhance the bond between the substrate 11 and the anti-fingerprint film 13. The targets are unaffected by the pre-cleaning process.

The anti-fingerprint film 13 is vacuum sputtered on the pretreated substrate 11. Vacuum sputtering of the anti-fingerprint film 13 is implemented in the plating chamber of the vacuum sputtering equipment. The inside of the plating chamber is heated from about 20° C. to about 200° C. Argon (Ar) is adjusted at a flow rate of about 300 to about 500 sccm to be injected into the chamber. Oxygen (O₂) is used as reaction gas and injected into the chamber at a flow rate of about 15 to about 120 sccm respectively, Power is applied to the target fixed in the plating chamber, and the substrate 11 may be biased with negative bias voltage to deposit the anti-fingerprint film 13 on the substrate 11. The negative bias voltage may be about −100 V to about −300 V. Depositing of the anti-fingerprint film 13 may take about 5-60 minutes.

From the above process, the tin oxide forms a plurality of nano mastoid structures on the anti-fingerprint film 13. A plurality of nano air vents on the anti-fingerprint film 13 achieved from the above process are defined between the nano mastoid structures. When water or oil contacts the surface of the anti-fingerprint film 13, the air vents are sealed by the water or oil to form air seal to prevent water or oil from wetting the anti-fingerprint film 13 to result in an anti-fingerprint property. The coarse or rugged surface of the substrate 11 further increases the number of the nano mastoid structures. The anti-fingerprint film 13 from the above process has a wetting angle of over 95%. This evidences the exemplary anti-fingerprint film 13 has a good anti-fingerprint property.

The method uses an environmentally friendly vacuum sputtering process to get an anti-fingerprint property. In addition, tin oxide is firmly attached to the surface of the substrate, increasing mechanical stability of the anti-fingerprint film 13.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A device housing, comprising:
a substrate; and
an anti-fingerprint film formed on the substrate, the anti-fingerprint film comprising a nano-composite coating consisting essentially of tin oxide.

2. The device housing as claimed in claim 1, wherein the anti-fingerprint film has a thickness under 2000 nm.

3. The device housing as claimed in claim 2, wherein the anti-fingerprint film has a thickness of about 100-500 nm.

4. The device housing as claimed in claim 1, wherein the substrate is made of metal or non-metal material.

5. The device housing as claimed in claim 1, wherein the substrate has a coarse or rugged surface having roughness at a range between about 0.1 μm and about 0.2 μm.

6. A method for making a device housing, comprising:
providing a substrate; and
forming an anti-fingerprint film on the substrate by vacuum sputtering, the anti-fingerprint film comprising nano-composite coating consisting essentially of tin oxide.

7. The method as claimed in claim 6, wherein vacuum sputtering the anti-fingerprint film uses a target made of tin; uses oxygen as reaction gases, the oxygen has a flow rate of about 15-120 sccm, uses argon as a working gas, the argon has a flow rate of about 300-400 sccm; vacuum sputtering the anti-fingerprint film is at a temperature of about 20-200° C., vacuum sputtering the anti-fingerprint film may take for about 5-60 minutes.

8. The method as claimed in claim 7, wherein the substrate is biased with a negative bias voltage of about −100V to about −300V during vacuum sputtering the anti-fingerprint film.

9. The method as claimed in claim 7, further comprising a step of pre-treating the substrate before forming the anti-fingerprint film.

10. The method as claimed in claim 9, wherein the pre-treating process comprising ultrasonic cleaning the substrate and plasma cleaning the substrate.

11. The method as claimed in claim 6, wherein the substrate is made of metal material or non-metal material.

12. The method as claimed in claim 11, wherein if the substrate is made of metal, the metal is selected from a group consisting of stainless steel, aluminum, aluminum alloy, copper, copper alloy, and zinc, and if the substrate is made on a non-metal material, the non-metal material is selected from the group consisting of plastic, ceramic, and glass.
